(19) United States
(12) Patent Application Publication
(10) Pub. No.: US 2007/0031657 A1
(43) Pub. Date: Feb. 8, 2007

(54) Ream wrap having white or colored poly coating

(76) Inventors: Michael R. Nowak, Hilbert, WI (US); LouAnn S. Mueller, Little Chute, WI (US); Michael Van Abel, Kaukauna, WI (US)

Correspondence Address: WEISS & WEISS, Suite 251, 300 Old Country Road, Mineola, NY, 11501, US

(21) Appl. No.: 11/580,426

(22) Filed: Oct. 12, 2006

Related U.S. Application Data
(63) Continuation of application No. 10/340,308, filed on Jan. 10, 2003, now abandoned.
(60) Provisional application No. 60/348,044, filed on Jan. 11, 2002.
(60) Provisional application No. 60/360,221, filed on Feb. 27, 2002.

(51) Int. Cl. B32B 23/08; B32B 27/10; B32B 27/20

(52) U.S. Cl. 428/342; 428/537.5; 428/513

(57) ABSTRACT

A ream wrapper made of an unbleached (brown) paper or a semi-bleached (tan) paper with a white poly or colored poly coating.

### RELATED APPLICATIONS

The following application is a continuation of application Ser. No. 10/340,308 filed Jan. 10, 2003.

### FIELD OF THE INVENTION

The present invention relates to a ream wrapper made of an unbleached (brown) paper or a semi-bleached (tan) paper with a white poly or colored poly coating.

### BACKGROUND OF THE INVENTION

Reams (i.e., 500 sheets) of cut paper (8½×11, etc.) for copy machines, computers, printers, and other applications are most commonly packaged for shipping, storage, and retail sale in ream wrap made of various wrap materials. These wrap materials traditionally have been 25-pound per 3,000 sq. ft. paper laminated to a 25-pound paper per 3,000 sq. ft. with 7 to 12 pounds per 3,000 sq. ft. of polyethylene. In many cases, the two papers were bleached or white papers. The outside of the wrapper was generally printed to identify the paper mill or distributor of the product. In some cases, the wrapper would be bleached (white) 25-pound paper on the outside, but an unbleached or brown paper on the inside laminated together with polyethylene. This type of wrapper was less expensive and perceived as more environmentally friendly since the inside paper did not go through a bleaching process. The white paper on the outside still maintained a good printing surface.

Ream wrapper has recently moved from the lamination of two papers with polyethylene to a heavier weight sheet of paper, usually 40 to 60 pounds per 3,000 sq. ft., coated with polyethylene on one side. This product is generally stronger and easier to work with than the laminated product. With this change, it was no longer possible to use the unbleached (brown) or semi-bleached (tan) paper if a print surface was desired on the outside of the wrapper, as only one sheet of paper was being used. As retail and store distribution of reamed paper has increased, manufacturers have placed more emphasis on a ream wrap's improved printing surface to enhance graphics and provide eye-appealing wrapped product for the customer. Equally important as the aesthetic appeal of the outer package is the identification of the manufacturer of the wrapped paper through the printed graphics or the color of the outer packaging.

Another disadvantage of current and conventional ream wraps is that they are non-transparent and do not permit the consumer to view the color of the reamed paper encased in the wrapper. Viewing the contents of the wrapped products is important, in particular, when reams of colored paper (other than white) are contained in the package.

### SUMMARY OF THE INVENTION

A ream wrapper comprising an unbleached (brown) paper or a semi-bleached (tan) paper with a white poly coating. It is an object of the present invention for the ream wrapper to have a white print surface for the outside of the ream wrap. It is an object of the present invention for the ream wrapper to provide a moisture barrier. It is an object of the present invention for the paper to have a weight between about 25 to 75 pounds per 3,000 sq. ft. It is an object of the present invention for the coating to have a weight of about 7 to 15 pounds per 3,000 sq. ft. It is an object of the present invention for the unbleached paper to be 40 pound bag and laminating Kraft, 50 pound extensible Kraft, and 60 pound converting Kraft. It is an object of the present invention for the white poly coating to be made by mixing polyethylene or polypropylene with a white dye or pigment.

The present invention relates to a ream wrapper comprising either an unbleached (brown), semi-bleached (tan), or bleached (white) paper with a colored poly coating. It is an object of the present invention for the paper to have a weight between about 25 to 75 pounds per 3,000 sq. ft. It is an object of the present invention for the paper to have a weight between about 40 to 60 pounds per 3,000 sq. ft. It is an object of the present invention for the coating to have a weight of about 7 to 15 pounds per 3,000 sq. ft. It is an object of the present invention for the colored poly coating to be made by mixing polyethylene, polypropylene, or a combination with a dye or pigment. It is an object of the present invention for the ream wrapper to provide a high quality printing surface for the outside of the ream wrap in a color that enhances printing graphics, instantly identifies a manufacturer of the wrapped paper product, and/or identifies the color of the paper encased in the ream wrap. It is an object of the present invention for the ream wrap to act as a moisture barrier, protect against physical damage, and use, more environmentally friendly unbleached (brown) or semi-bleached (tan) paper while still providing an enhanced printing surface. It is an object of the present invention for the ream wrap color to match the color of the paper contained inside the wrapped package.

The present invention relates to a method of preparing a colored poly ream wrapper comprising: mixing polyethylene, polypropylene, or a combination with a dye or pigment to form a poly mixture. The mixture is then coated on either side of about a 40 or 60 pound unbleached (brown), semi-bleached (tan), or bleached (white) paper.

The present invention relates to a method for making a white poly coated ream wrap comprising: mixing a blend of low density polyethylene or polypropylene with a white pigment or dye additive resulting in a white opaque film. The white film is coated on an unbleached (brown) paper or a semi-bleached (tan) paper.

The present invention relates to a method of making a colored poly coating comprising: mixing a blend of low density polyethylene or polypropylene with a blue pigment or dye additive resulting in a blue opaque film. The blue opaque film is coated on an unbleached (brown), semi-bleached (tan), or unbleached (white) paper.

It is an object of the present invention for the poly coating to be mixed to match a particular shade recognizable of a manufacturer. It is an object of the present invention for the poly coating to result in a high gloss printing surface, an eye-appealing ream wrap package, a moisture barrier, and a strong packaging material that protects wrapped paper from physical damage. It is an object of the present invention for the polyethylene, polypropylene, or polyethylene-polypropylene mix to be blended with a colored dye or pigment that matches the color of the paper being encased in the ream wrap.

The present invention relates to a ream wrapper comprising: a bleached, semi-bleached or natural paper substrate having a basis weight of between about 25-75 pounds/3,000 sq. ft. The substrate is coated on one side with about 7-15 pounds of polyethylene, polypropylene, polymer resin, copolymer and/or terpolymer resins alone or blended with polyester. The coating is white or colored with a pigment or dye additive that results in a white or colored opaque product.

The present invention relates to a ream wrapper comprising: a solid plastic film substrate coated with a white or colored poly coating which results in a colored or white film wrapper.

It is an object of the present invention to allow the use of the more friendly environmentally unbleached (brown) paper or a semi-bleached (yellowish) paper which is also more environmentally friendly in the pulping process, while still providing a white printing surface.

An object of the present invention is to provide a wrapper that promotes instant recognition of the manufacturer and an improved printing surface as well as an attractive outer package for the consumers and end-users to view on office and retail shelves.

### DETAILED DESCRIPTION OF THE INVENTION

In an embodiment of the present invention a ream wrapper comprises an unbleached (brown) paper or a semi-bleached (tan) paper with a white poly coating. The white polyethylene coating results in a white print surface for the outside of the ream wrap.

Examples of unbleached paper are 40 pound bag and laminating Kraft, 50 pound extensible Kraft, and 60 pound converting Kraft.

In one embodiment, the white poly coating is made by mixing polyethylene or polypropylene with a white dye or pigment.

In one example, the white poly coating is made by mixing a blend of low density polyethylene or white polypropylene with a white pigment or dye additive resulting in a white opaque film. The white poly coating is then coated on the unbleached (brown) paper or a semi-bleached (tan) paper. The white polyethylene coating results in a white print surface for the outside of the ream wrap.

In a further embodiment, the ream wrapper comprises an unbleached (brown), semi-bleached (tan), or bleached (white) paper having a weight between about 40 to 60 pounds per 3,000 sq. ft. coated with about 7 to 15 pounds per 3,000 sq. ft. of a colored poly. The colored poly coating results in an enhanced printing surface for the outside of the ream wrap as well as a colored outer package that provides instant recognition of either paper manufacturer or the color of the paper encased in the ream wrap.

In an embodiment, the colored poly coating is made by mixing polyethylene, polypropylene or a combination with a dye or pigment. The poly mixture is then coated on either side of an about 40 to 60 pound unbleached (brown), semi-bleached (tan), or bleached (white) paper.

In one embodiment, the colored poly coating is made by mixing polyethylene or polypropylene with a blue dye or pigment. The blue poly mixture is then coated on either side of an about 40 to 60 pound unbleached (brown), semi-bleached (tan), or bleached (white) paper.

In an example, the colored poly coating is made by mixing a blend of low density polyethylene or polypropylene with a blue pigment or dye additive resulting in a blue opaque film. The colored poly mixture is then coated on the unbleached (brown), semi-bleached (tan), or unbleached (white) paper.

In a preferred embodiment, the blue poly coating is mixed to match the particular shade of blue recognizable in the packaging of an identified paper manufacturer. The blue poly coating also results in a high gloss printing surface, an eye-appealing ream wrap package, a moisture barrier, and a strong packaging material that protects the wrapped paper from physical damage.

In another embodiment, the polyethylene, polypropylene, or polyethylene-polypropylene mix is blended with a colored dye or pigment that matches the color of the paper being encased in the ream wrap. The colored poly coating then results in a colored wrapper that enables consumers and end-users to identify the color of the wrapped product.

A preferred embodiment comprises a paper substrate (bleached, semi-bleached or natural) with a basis weight of between about 25-75 pounds/3,000 sq. ft., and being of any paper type (e.g., machine-glazed, machine-finished, clay-coated, etc.). The substrate is coated on one side with about 7-15 pounds of polyethylene or polypropylene (poly, polymer resin, copolymer and/or terpolymer resins alone or blended with polyester) that is white or colored with a pigment or dye additive that results in a white or colored opaque product. The final product may or may not be printed.

A further embodiment is to use a solid plastic film substrate and cover it with a white or colored poly coating to result in a colored or white film wrapper (printed or non-printed).

1. A ream wrapper comprising:
an unbleached (brown) paper or a semi-bleached (tan) paper with a white poly coating.

2. The ream wrapper of claim 1 wherein said wrapper has a white print surface for the outside of said ream wrap.

3. The ream wrapper of claim 1 wherein said paper has a weight between about 25 to 75 pounds per 3,000 sq. ft.

4. The ream wrapper of claim 1 wherein said coating has weight of about 7 to 15 pounds per 3,000 sq. ft.

5. The ream wrapper of claim 1 wherein said wrapper provides a moisture barrier.

6. The ream wrapper of claim 1 wherein said unbleached paper is selected from the group consisting of 40 pound bag and laminating Kraft, 50 pound extensible Kraft, or 60 pound converting Kraft.

7. The ream wrapper of claim 1 wherein said white poly coating is made by mixing polyethylene or polypropylene with a white dye or pigment.

8. A ream wrapper comprising either an unbleached (brown), semi-bleached (tan), or bleached (white) paper with a colored poly coating.

9. The ream wrapper of claim 8 wherein said paper has a weight between about 40 to 60 pounds per 3,000 sq. ft.

10. The ream wrapper of claim 8 wherein said paper has a weight between about 25 to 75 pounds per 3,000 sq. ft.

11. The ream wrapper of claim 8 wherein said coating has a weight of about 7 to 15 pounds per 3,000 sq. ft.

12. The ream wrapper of claim 8 wherein said colored poly coating is made by mixing polyethylene, polypropylene, or a combination with a dye or pigment.

13. The method of claim 8 wherein said polyethylene, polypropylene, or polyethylene-polypropylene mix is blended with a colored dye or pigment that matches color of paper being encased in said ream wrap.

14. The ream wrapper of claim 8 wherein said wrapper provides a high quality printing surface for the outside of said ream wrap in a color that enhances printing graphics, instantly identifies a manufacturer of wrapped paper product, and/or identifies color of paper encased in said ream wrap.

15. The ream wrapper of claim 8 wherein said ream wrap acts as a moisture barrier, protects against physical damage, and uses, more environmentally friendly unbleached (brown) or semi-bleached (tan) paper while still providing an enhanced printing surface.

16. The ream wrapper of claim 8 wherein said ream wrap color matches color of paper contained inside wrapped package.

17. A method of preparing a colored poly ream wrapper comprising:
mixing polyethylene, polypropylene, or a combination with a dye or pigment to form a poly mixture;
coating said poly mixture on either side of an unbleached (brown), semi-bleached (tan), or bleached (white) paper.
